(19) United States
(12) Patent Application Publication
(10) Pub. No.: US 2011/0268831 A1
(43) Pub. Date: Nov. 3, 2011

(54) Ice cream scoop

(75) Inventors: Tung-Hsien Lee, Yongkang City (TW); Sheng-Chi Lin, Tainan City (TW)

(73) Assignee: INTERCONTINENTAL MARKETING SERVICES FAR EAST CO., LTD., Chung Ho City (TW)

(21) Appl. No.: 12/772,593

(22) Filed: May 3, 2010

(51) Int. Cl. A23G 9/28

(52) U.S. Cl. 425/118

(57) ABSTRACT

An ice cream scoop includes a handle, a scooper coupled to an end of the handle, a scraper installed in the scooper, a link rod extended from an end of the scraper into the end of the handle, and a transmission device installed on the link rod. The ice cream scoop further includes an operating device with an end pivotally coupled to the handle, such that the operating device can be swayed between a first position and a second position with respect to the handle. The operating device further includes a driving portion coupled to the transmission device. If the operating device is swayed between the first and second positions, the link rod will be rotated, and the scraper will be moved along an internal wall of the scooper.

### BACKGROUND OF THE INVENTION

1. Field of the Invention

The present invention relates to an ice cream scoop, and more particularly to an improved manually operating ice cream scoop.

2. Description of the Related Art

Ice cream scoop is used extensively for serving ice cream by making and depositing ice cream balls. A conventional ice cream scoop generally includes a hemispherical scooper, a handle coupled to the scooper, a semi-circular scraper installed in the scooper, a link rod coupled to an end of the scraper, and a gear combined with the link rod. The handle includes two separated handle portions, and a spring installed between the two handle portions. The two handle portions can be operated to move towards each other or apart from each other by an elastic force. If a user holds the handle and applies a force to move the two handle portions towards each other, the gear of the link rod will be driven to move the scraper along an internal wall of the scooper, so as to scrap an ice cream ball from the scooper. However, the conventional ice cream scoop usually comes with a relatively large size which is inconvenient for users to hold. Furthermore, the link rod and the gear of the conventional ice cream scoop are exposed to the outside, not just causing a poor appearance look only, but also becoming dirty or damaged easily. In addition, the link rod of the conventional ice cream scoop is relatively long and thus incurs higher material and manufacturing costs.

### SUMMARY OF THE INVENTION

Therefore, it is a primary objective of the present invention to overcome the shortcomings of the prior art by providing an ice cream scoop with a convenient operation, a small size, and a good appearance, and the advantages of saving costs and uneasy to get dirty or damaged.

To achieve the foregoing objective, the present invention provides an ice cream scoop comprising a handle, a scooper, a scraper, and an operating device. The handle includes a first end and a second end separated from each other and disposed along a longitudinal axis of the handle, and a chamber formed in the first end of the handle. The scooper includes a hemispherical internal wall that defines an opening of the scooper, and the scooper is coupled to the first end of the handle. The scraper is swingingly installed in the scooper and includes a first end and a second end separated from each other and disposed on the longitudinal to axis, and the first end of the scraper is pivotally coupled to the scooper, and a link rod is extended from the second end of the scraper, passed through the scooper, and extended into a chamber at the first end of the handle, and a transmission device is installed onto the link rod and includes a plurality of transmission gear teeth. The operating device includes a first distal portion and a second distal portion separated from each other and disposed on the longitudinal axis, and an end of the operating device is pivotally coupled to the handle, such that the operating device can be swayed between a first position and a second position of the handle. The operating device further includes a driving portion having a plurality of separated grooves, wherein at least one of the grooves is engaged with one of the transmission devices. The operating device is normally situated at the first position. If the operating device is swayed between the first position and the second position, the link rod will be rotated, and the scraper will be swayed along the internal wall of the scooper.

Preferably, the first distal portion of the operating device is pivotally coupled to the first end of the handle by a pin, and a spring is sheathed onto the pin and contained in the chamber of the first end of the handle, and both distal ends of the spring are abutted against the handle and the operating device for moving the operating device to the first position.

In a preferred embodiment, the handle further includes an upper portion and a lower portion separated from each other and arranged in a heightwise direction perpendicular to the longitudinal axis, and an installing hole is formed at the upper portion of the first end of the handle and interconnected to the chamber of the handle. The operating device is installed through the installing hole into the chamber of the first end of the handle, and the plurality of grooves of the operating device are separated from each other and arranged in the heightwise direction. The scooper includes an upper end and a lower end separated from each other and arranged in the heightwise direction, and an opening of the scooper is disposed at the upper end of the scooper.

The foregoing and other objectives, advantages and characteristics of the invention will become apparent with the detailed description of preferred embodiments and the illustration of related drawings as follow.

### BRIEF DESCRIPTION OF THE DRAWINGS

FIG. 1 is a perspective view of an ice cream scoop in accordance with a preferred embodiment of the present invention;

FIG. 2 is an exploded view of an ice cream scoop in accordance with a preferred embodiment of the present invention;

FIG. 3 is a cross-sectional view of an ice cream scoop in accordance with a preferred embodiment of the present invention;

FIG. 4 is a cross-sectional view of Line A-A of FIG. 3;

FIG. 5 is a schematic view of operating an ice cream scoop in accordance with the present invention;

FIG. 6 is a cross-sectional view of an ice cream scoop as depicted in FIG. 5; and

FIG. 7 is a cross-sectional view of Line 7-7 of FIG. 6.

### DETAILED DESCRIPTION OF THE PREFERRED EMBODIMENTS

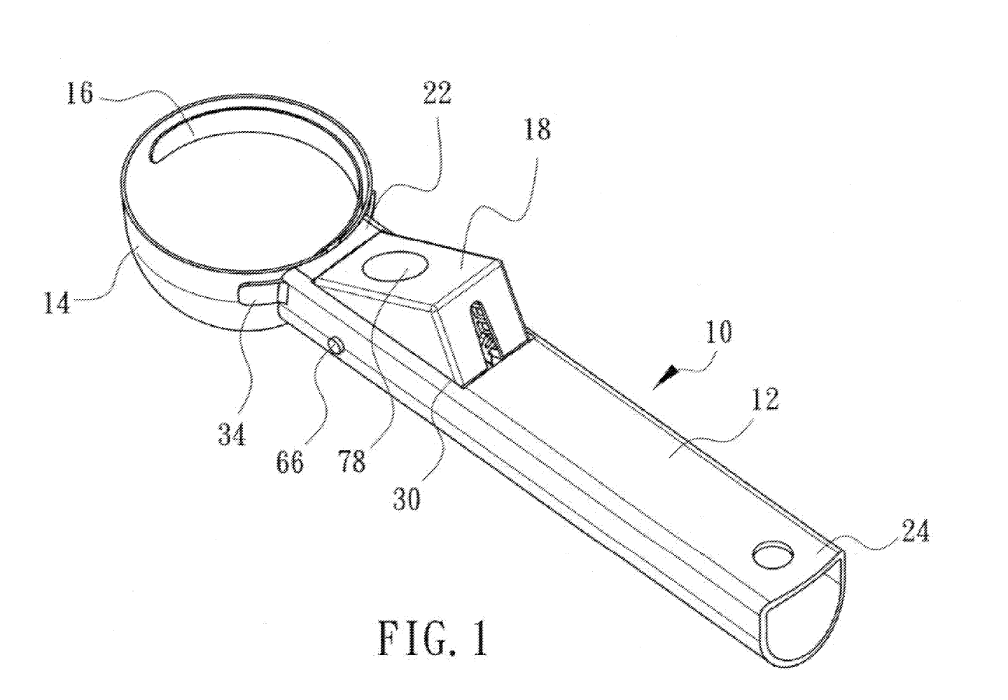

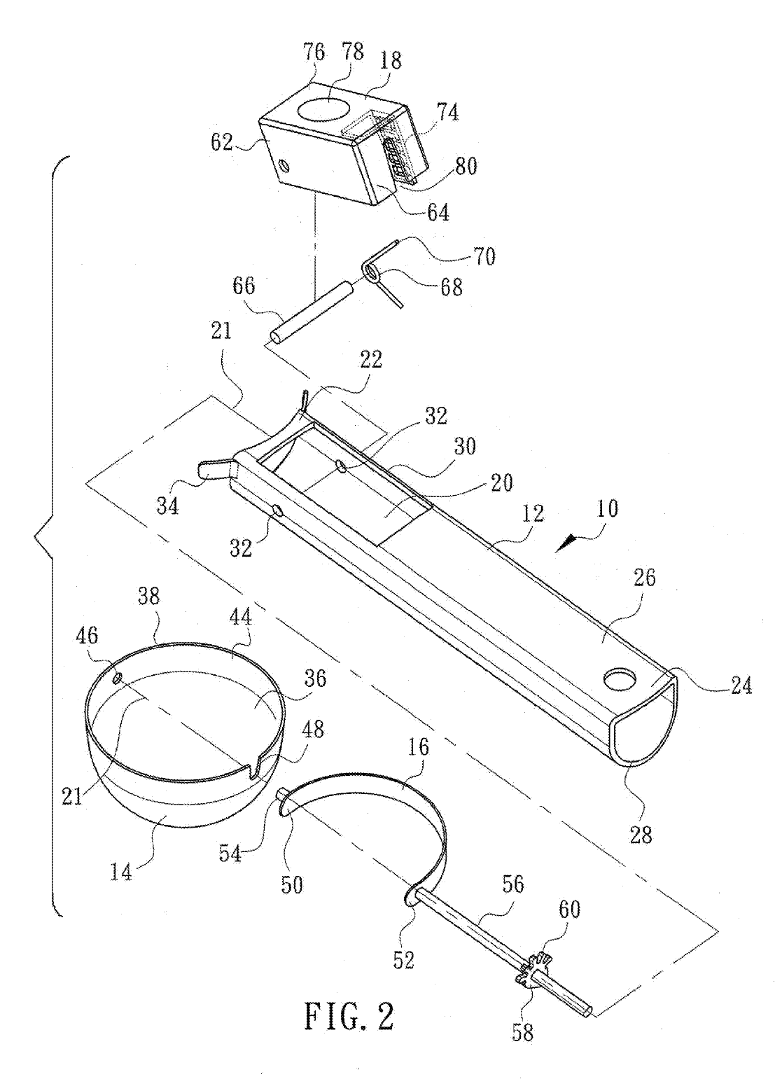

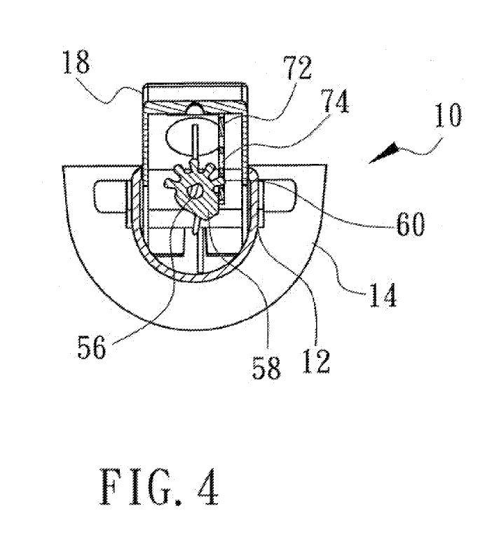

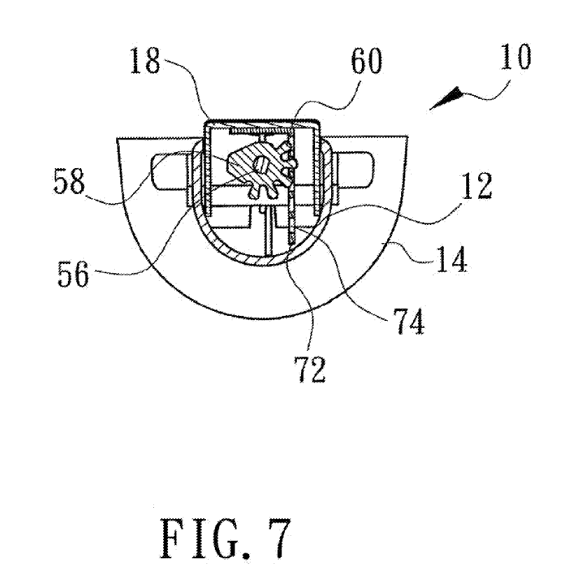

With reference to FIGS. 1 to 7 for an ice cream scoop 10 in accordance with a preferred embodiment of the present invention, the ice cream scoop 10 comprises a handle 12, a scooper 14, a scraper 16 and an operating device 18.

The handle 12 is a pipe containing a chamber 20 therein, and the handle 12 includes a first end 22 and a second end 24 separated from each other and disposed on a longitudinal axis 21, and the handle 12 further includes an upper portion 26 and a lower portion 28 separated from each other and arranged in a heightwise direction perpendicular to the longitudinal axis 21, and an installing hole 30 is formed at the upper portion 26 of the first end 22 of the handle 12 and interconnected to the chamber 20. Two through holes 32 are formed on both sides of the first end 22 of the handle 12 respectively, and each through hole 32 is interconnected to the chamber 20 of the handle 12. In addition, a connecting plate 34 is extended separately from both sides of the first end 22 of the handle 12.

The scooper 14 is a case having a hemispherical internal wall 36, and coupled to the connecting plate 34 of the first end 32 of the handle 12. The scooper 14 includes an upper end 38 and a lower end 40 separated from each other and disposed on the heightwise direction, and a circular edge having a circular opening defined therein is disposed at the upper end 38 of the scooper 14 and provided for scooping ice cream. A first hole 46 and a second hole 18 are formed at the upper end 38 of the scooper 14, separated from each other, and disposed on the longitudinal axis 21, and the second hole 48 is proximate to the first end 22 of the handle 12.

The scraper 16 is a semicircular plate swingingly installed in the scooper. The scraper 16 includes a first end 50 and a second end 52 separated from each other and disposed on the longitudinal axis 21, and a pillar 54 is extended from the first end 50 of the scraper 16 and inserted into and coupled to the first hole 46 of the scooper. A link rod 56 is extended from the second end 52 of the scraper 16, passed through the second hole 48 of the scooper 14, and extended along the longitudinal axis 21 into the chamber 20 at the first end 22 of the handle 12. A transmission device 58 in a gear shape is installed onto the link rod 56, and includes a plurality of transmission gear teeth formed around the periphery of the transmission device 58.

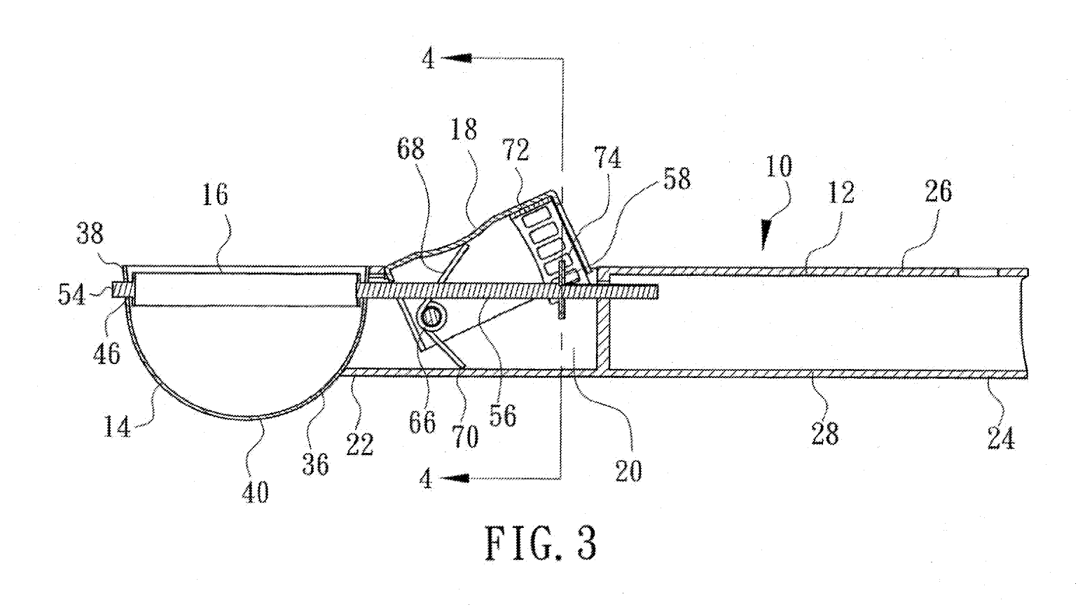

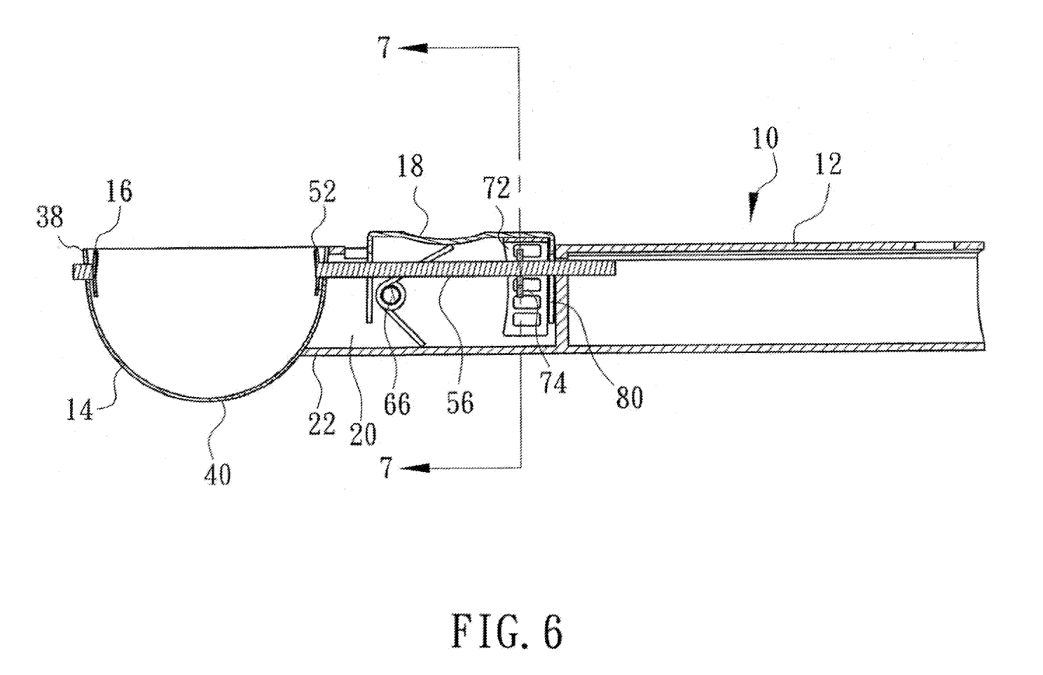

The operating device 18 is installed into a case in the installing hole 30 of the handle 12. The operating device 18 includes a first distal portion 62 and a second distal portion 64 separated from each other and disposed on the longitudinal axis 21. A pin 66 is passed through the first distal portion 62 of the operating device 18 and pivotally coupled to the first end 22 of the handle 12, such that the operating device 18 can be swayed between the first and second positions of the handle 12 by using the pin 66 as the pivotal axis. In this preferred embodiment, both ends of the pin 66 are inserted and fixed into the two through holes 32 of the first end 22 of the handle 12 respectively. A torque spring 68 is sheathed onto the pin 66 for providing a position restoring effect to the operating device 18 and accommodated in the chamber 20 of the first end 22 of the handle 12, and both distal ends 70 of the spring 68 are abutted against the handle 12 and the operating device 18 respectively, such that the operating device 18 is normally moved to the first position by the resilience of the spring 68. If the operating device 18 is situated at the first position, the second distal portion 64 of the operating device 18 is tilted upward with respect to the handle 12 (as shown in FIG. 3). The operating device 18 can be operated to move from the first position to the second position. When the operating device 18 is situated at the second position, both distal ends 70 of the spring 68 are pressed, and the second distal portion 64 of the operating device 18 is substantially horizontal with respect to the handle 12 (as shown in FIG. 6). In addition, the operating device 18 further includes a driving portion 72 which is an L-shaped board in this preferred embodiment and coupled into the operating device 18. It is noteworthy to point out that the driving portion 72 can be integrally formed with the operating device 18 in another preferred embodiment. The driving portion 72 includes a plurality of grooves 74 separated from each other and arranged in the heightwise direction, and at least one of the grooves 74 is engaged with one of the transmission gear teeth 60, such that when the operating device 18 is swayed between the first and second positions, the link rod 56 will be driven and rotated. The operating device 18 further includes a top 76, a recession formed at the top 76 and provided for users to press by a finger. In addition, a through groove 80 is formed at the second end of the operating device 18 and provided for passing the link rod 56, so as to prevent interference with the link rod 56 when the operating device 18 is swayed.

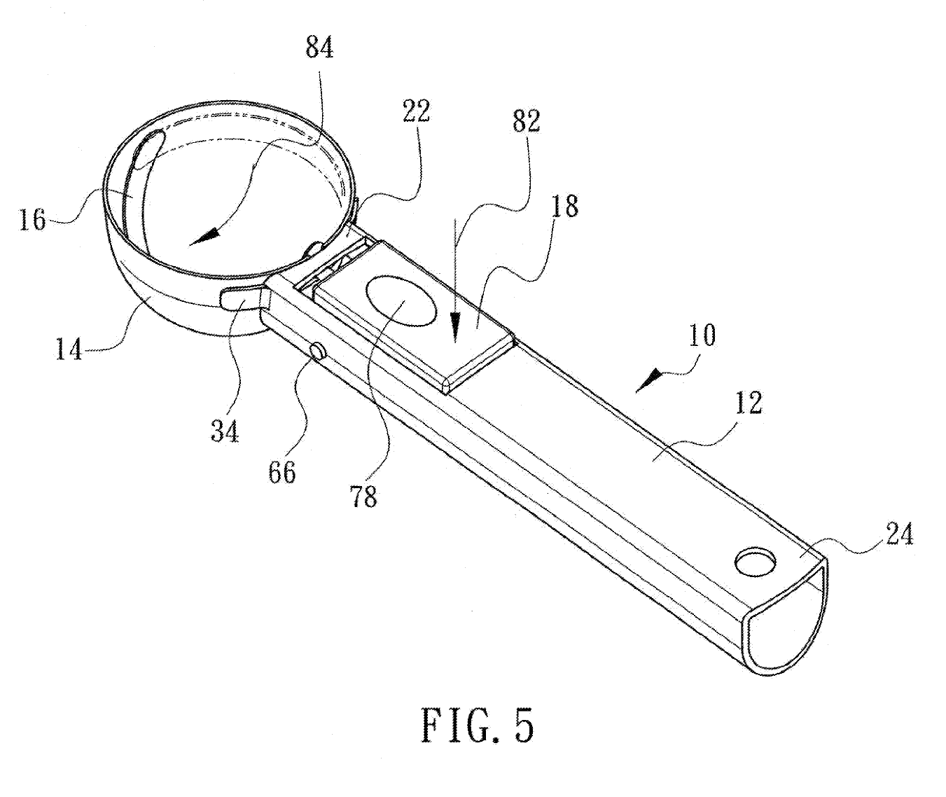

After the ice cream scoop of the invention scoops an ice cream ball, a user can press the operating device 18 (as indicated by the arrow 82 in FIG. 5) to scrap the ice cream ball contained in the scooper 14 from the scooper 14. The operating device 18 can be returned from the second position to the first position by means of the resilience of the spring 68 (as shown in FIG. 3).

While the invention has been described by means of specific embodiments, numerous modifications and variations could be made thereto by those skilled in the art without departing from the scope and spirit of the invention set forth in the claims.

What is claimed is:

1. An ice cream scoop, comprising:
a handle, having a first end and a second end separated from each other and disposed on a longitudinal axis, and a chamber contained in the first end of the handle;
a scooper, having a hemispherical internal wall, and coupled to the first end of the handle;
a scraper, swingingly installed in the scooper, and having a first end and a second end separated from each other and disposed on the longitudinal axis, and a first end of the scraper being pivotally coupled to the scooper, and a link rod being extended from the second end of the scraper, passed through the scooper, and extended into the chamber of the first end of the handle, and a transmission device being installed on the link rod, and the transmission device including a plurality of transmission gear teeth; and
an operating device, having a first distal portion and a second distal portion separated from each other and disposed on the longitudinal axis, and the first distal portion of the operating device being pivotally coupled to the handle, such that the operating device can be swayed between a first position and a second position with respect to the handle, and the operating device further including a driving portion, and the driving portion having a plurality of grooves separated from each other, and at least one of the grooves being engaged with one of the transmission gear teeth of the transmission device, and the operating device being normally situated at the first position, and if the operating device is operated to sway between the first position and the second position, the link rod will be rotated, and the scraper will be swayed along the internal wall of the scooper.

2. The ice cream scoop of claim 1, wherein the first end of the operating device is pivotally coupled to the first end of the handle by a pin, and a spring is sheathed onto the pin and accommodated in the chamber of the first end of the handle, and the spring has two distal ends abutted against the handle and the operating device respectively, and the operating device is normally situated at the first position by the resilience of the spring.

3. The ice cream scoop of claim 2, wherein the handle further includes an upper portion and a lower portion separated from each other and disposed in a heightwise direction perpendicular to the longitudinal axis, and an installing hole is formed at the upper portion of the first end of the handle and interconnected to the chamber of the handle, and the operating device is installed into the chamber of the first end of the handle through the installing hole, and the plurality of grooves of the operating device are separated from each other and arranged in the heightwise direction, and the scooper includes an upper end and a lower end separated from each other and arranged in the heightwise direction, and an opening defined by the hemispherical internal wall and disposed at the upper end of the scooper.

4. The ice cream scoop of claim 3, wherein the handle is a pipe, and two through holes are formed on both sides of the first end of the handle respectively, and each through hole is interconnected to the chamber of the handle, and both ends of the pipe are inserted into and coupled to the two through holes of the handle respectively.

5. The ice cream scoop of claim 4, wherein the second distal portion of the operating device is tilted upward with respect to the handle if the operating device is situated at the first position, and the second distal portion of the operating device is substantially horizontal with respect to the handle if the operating device is situated at the second position.

6. The ice cream scoop of claim 5, wherein the upper end of the scooper includes a first hole and a second hole separated from each other and disposed on the longitudinal axis, and the second hole is proximate to the first end of the handle, and a pillar is extended from the first end of the scraper and inserted into and coupled to the first hole of the scooper, and the link rod is passed through the second hole of the scooper.

7. The ice cream scoop of claim 6, wherein the driving portion of the operating device is coupled into the operating device, and the operating device further includes a top, a recession formed at the top and provided for a user to press and operate by a finger, and a through groove formed at the second distal portion of the operating device and provided for passing the link rod.
